(19) United States
(12) Patent Application Publication
(10) Pub. No.: US 2016/0134448 A1
(43) Pub. Date: May 12, 2016

(54) METHOD AND APPARATUS FOR GENERATING PILOT SIGNAL AND METHOD FOR ESTIMATING FREQUENCY OFFSET USING THE SAME

(71) Applicant: Electronics and Telecommunications Research Institute, Daejeon (KR)

(72) Inventors: Seung Nam CHOI, Daejeon (KR); Il Gyu KIM, Okcheon-gun Chungcheongbuk-do (KR); Jun Hwan LEE, Seoul (KR)

(21) Appl. No.: 14/939,474

(22) Filed: Nov. 12, 2015

(30) Foreign Application Priority Data
Nov. 12, 2014 (KR) 10-2014-0157426

(51) Int. Cl. H04L 27/00; H04L 5/00; H04L 27/26

(52) U.S. Cl. CPC H04L 27/0014; H04L 27/2647; H04L 5/0048; H04L 5/0007; H04L 2027/0026; H04L 2027/0065; H04L 2027/0087

(57) ABSTRACT

A method and apparatus for generating pilot signals in a mobile communication system and a method of estimating a frequency offset using the same are provided. In an environment in which a terminal moves at a high speed, pilot signals are disposed at a first interval in a first range of a transmission frame forming a single transmission unit. Furthermore, pilot signals are disposed at a second interval in a second range of the transmission frame. A frequency offset is estimated based on the pilot signals.

### CROSS-REFERENCE TO RELATED APPLICATION

This application claims priority to and the benefit of Korean Patent Application No. 10-2014-0157426 filed in the Korean Intellectual Property Office on Nov. 12, 2014, the entire contents of which are incorporated herein by reference.

### BACKGROUND OF THE INVENTION

(a) Field of the Invention

The present invention relates to a method and apparatus for generating pilot signals in a mobile communication system, and a method of estimating a frequency offset using the same.

(b) Description of the Related Art

In an environment in which a terminal moves at high speed, for example, in an environment in which a terminal is mounted on a high-speed train and moving at a high speed, communication performance is greatly deteriorated due to a Doppler shift. Specifically, the terminal receives a signal having a frequency that is shifted by a frequency offset due to a Doppler shift phenomenon compared to the transmission frequency of a base station. When the terminal sends a signal, the base station receives a signal having a frequency that is shifted by the frequency offset compared to the transmission frequency of the terminal. As described above, communication performance is deteriorated due to a frequency offset generated for signals that are transmitted/received by the terminal and the base station.

Accordingly, in order to prevent the deterioration of communication performance, a frequency offset needs to be estimated and compensated for.

In order to estimate a frequency offset, a terminal and a base station send a pilot signal (or a reference signal), that is, a signal known to both the terminal and the base station. In general, the terminal may estimate a channel and a frequency offset using the downlink pilot signal of the base station and compensate for the Doppler frequency offset of the downlink signal. Accordingly, it is required to efficiently design a pilot signal for estimating an accurate frequency offset.

### SUMMARY OF THE INVENTION

The present invention has been made in an effort to provide a method and apparatus for generating pilot signals in a mobile communication system and a method of estimating a frequency offset using the same, in which a base station can accurately estimate and compensate for a frequency offset in a high-speed moving environment.

According to an embodiment of the present invention, a method of generating pilot signals and a method of generating pilot signals in an environment in which a terminal moves at a high speed includes disposing pilot signals at a first interval in a first range of a transmission frame forming a single transmission unit and disposing pilot signals at a second interval in a second range of the transmission frame.

If the transmission frame includes a plurality of orthogonal frequency division modulation (OFDM) symbols in a time domain, one pilot signal may be disposed every first number of OFDM symbols, and one pilot signal may be disposed every second number of OFDM symbols.

In this case, the second number may be three times the first number.

Furthermore, the second range may be subsequent to the first range.

According to another embodiment of the present invention, a method of estimating, by a base station, a frequency offset based on pilot signals in an environment in which a terminal moves at high speed includes receiving a signal in which pilot signals are disposed at a first interval in the first range of a transmission frame forming a single transmission unit and pilot signals are disposed at a second interval in the second range of the transmission frame, estimating, by the base station, a first frequency offset based on the pilot signals disposed in the first range of the received signal, estimating a second frequency offset based on the pilot signals disposed in the second range of the received signal, and calculating a final frequency offset estimation value based on the first frequency offset and the second frequency offset.

If the transmission frame includes a plurality of orthogonal frequency division modulation (OFDM) symbols in a time domain, one pilot signal may be disposed every first number of OFDM symbols in the first range, and one pilot signal may be disposed every second number of OFDM symbols in the second range. The second number may be three times the first number.

According to yet another embodiment of the present invention, an apparatus for generating pilot signals in an environment in which a terminal moves at high speed includes a radio frequency converter configured to send and receive signals through an antenna and a processor connected to the radio frequency converter and configured to generate pilot signals, wherein the processor is configured to include a first pilot disposition unit configured to dispose pilot signals at a first interval in a first range of a transmission frame forming a single transmission unit and a second pilot disposition unit configured to dispose pilot signals at a second interval in a second range of the transmission frame.

If the transmission frame includes a plurality of orthogonal frequency division modulation (OFDM) symbols in a time domain, the first pilot disposition unit may dispose one pilot signal every first number of OFDM symbols, and the second pilot disposition unit may dispose one pilot signal every second number of OFDM symbols.

The second number may be three times the first number. The second range may be subsequent to the first range.

### BRIEF DESCRIPTION OF THE DRAWINGS

FIG. 1 is an exemplary diagram illustrating a high-speed moving environment In accordance with an exemplary embodiment of the present invention.

FIG. 2 is an exemplary diagram illustrating a frequency offset generated due to a Doppler shift in accordance with an exemplary embodiment of the present invention.

FIG. 3 is a diagram illustrating the structure of a frame for sending pilot signals in accordance with an exemplary embodiment of the present invention.

FIG. 4 is a diagram illustrating the structure of a frame for sending pilot signals in accordance with another exemplary embodiment of the present invention.

FIGS. 5 and 6 illustrate frequency ranges that may be estimated using the pilot signal of FIG. 4 in accordance with an exemplary embodiment of the present invention.

FIG. 7 is a flowchart illustrating a method of generating pilot signals in accordance with an exemplary embodiment of the present invention.

FIG. 8 is a flowchart illustrating a method of estimating a frequency offset in accordance with an exemplary embodiment of the present invention.

FIG. 9 is a diagram illustrating the configuration of an apparatus for generating pilot signals in accordance with an exemplary embodiment of the present invention.

### DETAILED DESCRIPTION OF THE EMBODIMENTS

In the following detailed description, only certain exemplary embodiments of the present invention have been illustrated and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising” will be understood to imply the inclusion of stated elements but not the exclusion of any other elements.

In the entire specification, a mobile station (MS) may refer to a terminal, a mobile terminal (MT), an advanced mobile station (AMS), a high reliability mobile station (HR-MS), a subscriber station (SS), a portable subscriber station (PSS), an access terminal (AT)), or user equipment (UE), and may include some or all of the functions of the MT, MS, AMS, HR-MS, SS, PSS, AT, and UE.

Furthermore, a base station (BS) may refer to an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station (RS) functioning as a base station, a relay node (RN) functioning as a base station, an advanced relay station (ARS) functioning as a base station, a high reliability relay station (HR-RS) functioning as a base station, or a small base station [e.g., a femoto BS, a home node B (HNB), a home eNodeB (HeNB), a pico BS, a metro BS, or a micro BS], and may include some or all of the functions of the ABS, nodeB, eNodeB, AP, RAS, BTS, MMR-BS, RS, RN, ARS, HR-RS, and small base station.

Hereinafter, a method and apparatus for generating pilot signals in a mobile communication system and a method of estimating a frequency offset using the same in accordance with exemplary embodiments of the present invention are described.

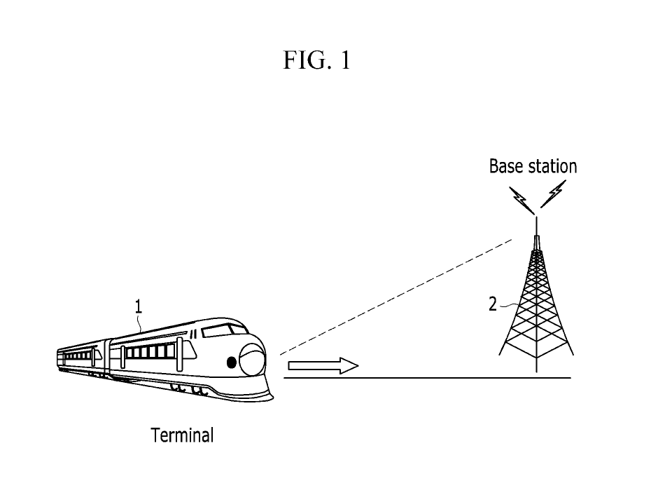

FIG. 1 is an exemplary diagram illustrating a high-speed moving environment In accordance with an exemplary embodiment of the present invention.

As illustrated in FIG. 1, in an environment in which a terminal 1 has been mounted on a moving body moving at a high speed, such as a high-speed train, the terminal 1 may transmit/receive signals to/from a base station 2. In such a high-speed moving environment, when signals are transmitted/received between the terminal 1 and the base station 2, a frequency offset attributable to the Doppler shift is generated.

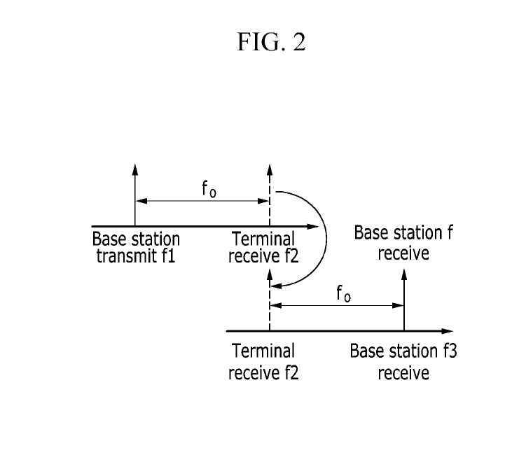

FIG. 2 is an exemplary diagram illustrating a frequency offset generated due to the Doppler shift in accordance with an exemplary embodiment of the present invention.

As illustrated in FIG. 2, when the terminal 1 receives a first signal from the base station 2, it receives the first signal having a frequency f2 that is shifted by a frequency offset f₀ due the Doppler shift compared to the transmission frequency f1 of the first signal transmitted by the base station 1. Thereafter, the terminal 1 estimates the frequency offset f₀ and uses the frequency f2 that is shifted by the frequency offset f₀ as the transmission frequency of the terminal.

Thereafter, the terminal 1 sends a second signal having the transmission frequency f2 to the base station 2. In this case, the base station 2 receives the second signal having a frequency f3 that is shifted by the frequency offset f₀ due to the Doppler shift compared to the transmission frequency f2 of the second signal transmitted by the terminal 1. Accordingly, an interval between the transmission frequency f1 of the base station 2 and the reception frequency f3 of the base station 2 is increased by a frequency offset 2f₀. Therefore, the base station 2 has to estimate and compensate for a frequency offset using the uplink pilot signal of the received signal (i.e., the second signal) shifted by the frequency offset 2f₀ in order to prevent transmission performance from being deteriorated. In this case, if the frequency offset 2f₀ cannot be estimated based on the pilot signal, the frequency cannot be compensated for.

In accordance with an exemplary embodiment of the present invention, a base station generates a pilot signal so that a frequency offset generated by the Doppler shift as described above can be estimated from a received signal.

A method of generating pilot signals in accordance with an exemplary embodiment of the present invention is described below.

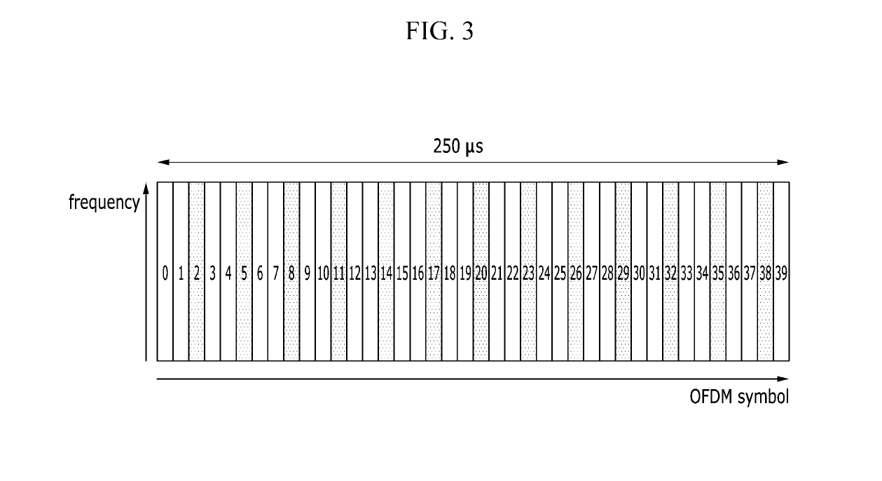

FIG. 3 is a diagram illustrating the structure of a frame for sending pilot signals in accordance with an exemplary embodiment of the present invention.

In uplink transmission using an orthogonal frequency division modulation (OFDM) method, it is assumed that the frame of a transmission unit (e.g., a subframe) has a structure such as that of FIG. 3. That is, as illustrated in FIG. 3, it is assumed that the frame includes 40 OFDM symbols and has a length of 250 ms.

In this case, assuming that a transmission frequency is 27 GHz, for example, and a terminal moves at a moving speed of 400 km/h, for example, in a high-speed moving environment such as that of FIG. 1, as illustrated in FIG. 2, a frequency offset of about ±10 kHz is generated in downlink and a frequency offset of about ±10 kHz is also generated in uplink due to the Doppler shift. Accordingly, a signal received by a base station is shifted by a maximum frequency of ±20 kHz.

In this state, if the base station needs to be able to estimate the frequency offset of ±20 kHz using the uplink signal, a symbol interval in which a pilot signal is disposed needs to be 3, as illustrated in FIG. 3. That is, a single pilot signal needs to be disposed every three OFDM symbols.

A frequency is determined by a change of a phase over time as in the following equation.

$$f = \frac{Δ ∅}{2 π Δ t} \qquad ( Equation 1 )$$

In this case, Δ denotes a change of a phase between two pilot signals, and Δt denotes a time difference between the two pilot signals. Δ is a value that is frequently changed due to moving speed of the terminal and a wireless channel environment, and Δt is a value that is fixed by the disposition of the pilot signals. Accordingly, a frequency offset that may be estimated by a receiving terminal is determined depending on which value Δt has. In OFDM, the value Δt may mean that a pilot signal is present in a number of symbols. Accordingly, a frequency offset value that may be estimated is increased as the value Δt is reduced.

For example, if the interval between OFDM subcarriers is 180 kHz and the moving speed of the terminal is 400 km/h, a frequency offset that may be estimated if a pilot signal is disposed every three OFDM symbols is ±26.67 kHz, and a frequency offset that may be estimated if a pilot signal is disposed every four OFDM symbols is ±20 kHz. In accordance with an exemplary embodiment of the present invention, a pilot signal has been illustrated as being disposed every three OFDM symbols by taking into consideration a case where the moving speed slightly exceeds 400 km/h, but is not limited thereto. Such a disposition of a pilot signal may vary depending on a carrier frequency, a subcarrier interval, and speed.

In accordance with an exemplary embodiment of the present invention, in a frame that forms a single signal transmission unit, a pilot signal may be disposed at a first interval (e.g., every three OFDM symbols).

In this case, if the pilot signal is disposed at the first interval, for example, 13 of a total of 40 OFDM symbols are used as the pilot signal. The interval between pilot signals needs to be narrow in a time domain as the value of a frequency offset to be estimated is increased. This is closely related to a data transmission capacity. Accordingly, if pilot signals are disposed using such a method, a data transmission capacity may be reduced because the pilot signals account for a portion of about 32.5% in a single subframe.

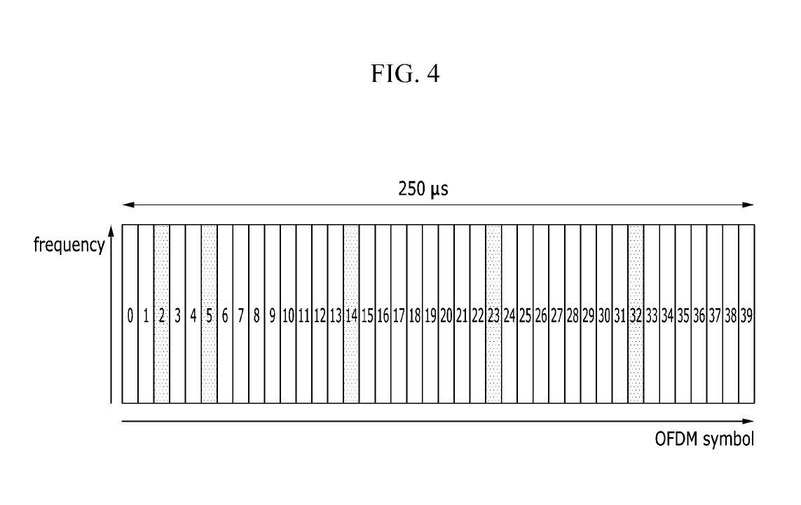

FIG. 4 is a diagram illustrating the structure of a frame for sending pilot signals in accordance with another exemplary embodiment of the present invention.

In accordance with an exemplary embodiment of the present invention, in a frame that forms a single signal transmission unit, pilot signals are disposed at a first interval in a first frequency range, and pilot signals are disposed at a second interval in a second frequency range.

It is assumed that in the same high-speed moving environment, such as that of FIG. 3, a frame having the same structure (e.g., a structure in which the frame has 40 OFDM symbols S0-S39 and has a length of 250 μs) is transmitted and the same frequency offset is generated due to a Doppler frequency.

In such an environment, as illustrated in FIG. 4, a pilot signal is disposed every three OFDM symbols in a first range (e.g., S0-S5), and a pilot signal is disposed every nine OFDM symbols in a second range (e.g., S6-S39).

An express bus or a subway having a moving speed of less than 160 km/h may be subject to a frequency offset of about ±8 kHz. If a pilot signal is disposed every ten OFDM symbols, a frequency offset that may be estimated is ±8 kHz, and if a pilot signal is disposed every nine OFDM symbols, a frequency offset that may be estimated is ±8.89 kHz.

As described above, in accordance with an exemplary embodiment of the present invention, a pilot signal is disposed every nine OFDM symbols in the second range so that a multiplication relation in which a pilot signal is present every three OFDM symbols is obtained by taking into consideration a moving speed of 400 km/h. However, the present invention is not limited to such an example.

If pilot signals are disposed in a single frame at different intervals for each range as described above, for example, 5 of the total of 40 OFDM symbols are used as the pilot signals. Accordingly, the pilot signals account for a portion of about 12.5% in all the symbols. Accordingly, compared to the disposition of pilot signals such as in FIG. 3, a relative reduction in the data transmission capacity can be improved.

Furthermore, if a pilot signal is generated and transmitted as described above, a frequency offset of about ±20 kHz that is generated in the aforementioned environment can be estimated, and transmission performance attributable to a frequency offset does not differ very much from the method of FIG. 3.

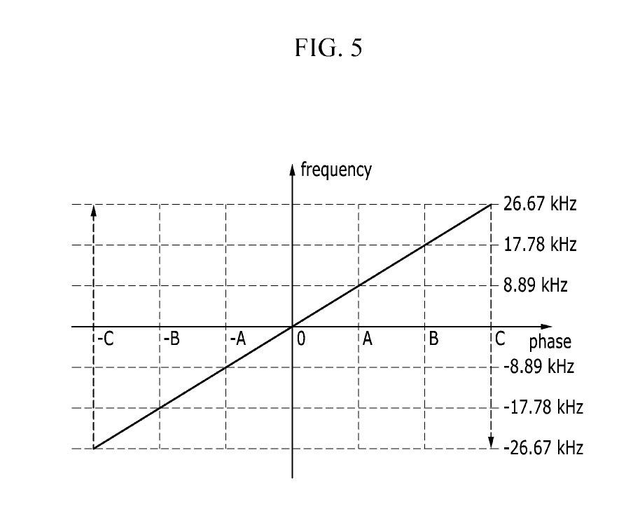

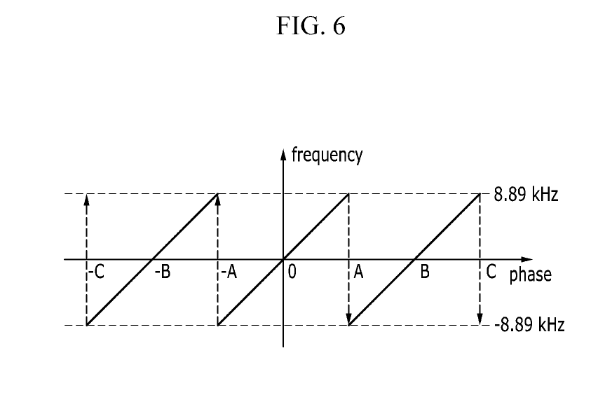

FIGS. 5 and 6 illustrate frequency ranges that may be estimated using the pilot signal of FIG. 4 in accordance with an exemplary embodiment of the present invention. Specifically, FIG. 5 illustrates a frequency range that may be estimated using pilot signals disposed in a first range, and FIG. 6 illustrates a frequency range that may be estimated using pilot signals disposed in a second range.

As illustrated in FIG. 5, for example, in a frame including 40 OFDM symbols, a frequency offset estimated using pilot signals (e.g., a pilot signal 2 and a pilot signal 5) disposed at a first interval in the first range is called f₁. Furthermore, as illustrated in FIG. 6, a frequency offset estimated using pilot signals (e.g., the pilot signal 5, a pilot signal 14, a pilot signal 23, and a pilot signal 32) disposed at a second interval in the second range is called f₂. In this case, the final frequency offset estimation value f₀ may be represented as in the following equation.

$${f}_{o} = \{ \begin{matrix}( {f}_{1} + {f}_{2} ) / 2 & if \vert {f}_{1} \vert \leq 8.89 kHz \\ ( {f}_{1} + {f}_{2} ) / 2 + 8.89 kHz & if {f}_{1} > 8.89 kHz \\ ( {f}_{1} + {f}_{2} ) / 2 - 8.89 kHz & if {f}_{1} < - 8.89 kHz\end{matrix} \qquad ( Equation 2 )$$

Accordingly, a base station can compensate for the Doppler shift of a received signal using the estimated frequency offset value f₀.

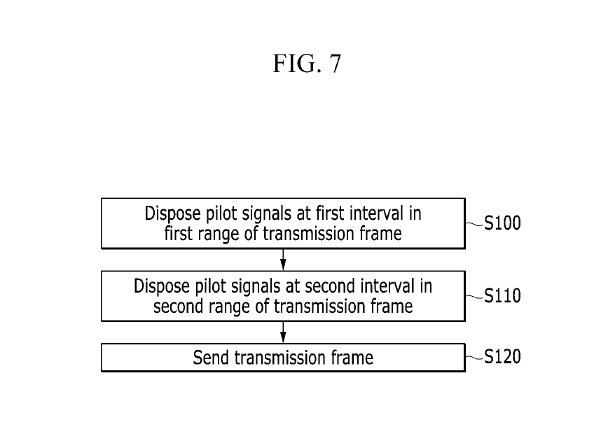

FIG. 7 is a flowchart illustrating a method of generating pilot signals in accordance with an exemplary embodiment of the present invention.

In an environment in which a terminal moves at high speed, if signals according to the OFDM method are transmitted/received to/from a base station, a pilot signal for estimating a frequency offset is generated.

Specifically, as illustrated in FIG. 7, if a transmission frame forming a single transmission unit includes a plurality of OFDM symbols in a time domain, a pilot signal is disposed at a first interval (e.g., at an interval of three OFDM symbols) in the first range of the OFDM symbols that form the transmission frame at step S100.

Furthermore, a pilot signal is disposed at a second interval (e.g., an interval or nine OFDM symbols) in a second range subsequent to the first range at step S110.

As described above, after the pilot signals are disposed at different intervals for each range in the transmission frame, the transmission frame including such pilot signals is transmitted at step S120.

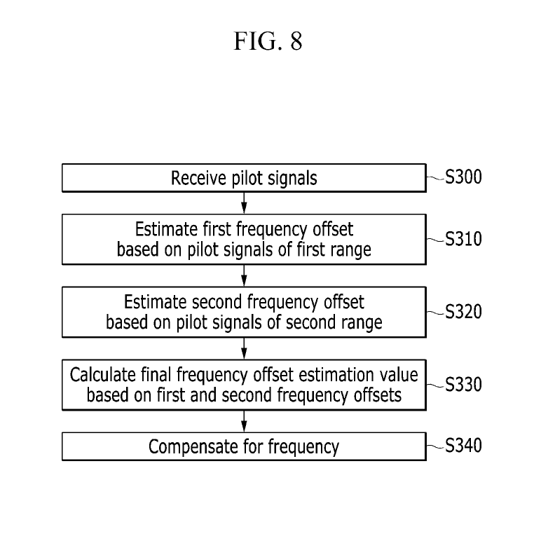

FIG. 8 is a flowchart illustrating a method of estimating a frequency offset in accordance with an exemplary embodiment of the present invention.

A base station receives pilot signals generated as in FIG. 7 at step S300. That is, the base station receives a transmission frame in which the pilot signals are disposed at the first interval in the first range and the pilot signals are disposed at the second interval in the second range.

The base station estimates a first frequency offset f₁ using the pilot signals disposed in the first range of the received transmission frame at step S310. Furthermore, the base station estimates a second frequency offset f₂ using the pilot signals disposed in the second range of the transmission frame at step S320.

Thereafter, the base station calculates a final frequency offset estimate f₀ based on first frequency offset and the second frequency offset at step S330. The final frequency offset estimate f₀ may be calculated according to Equation 1. The base station performs frequency compensation based on the final frequency offset estimate calculated as described above.

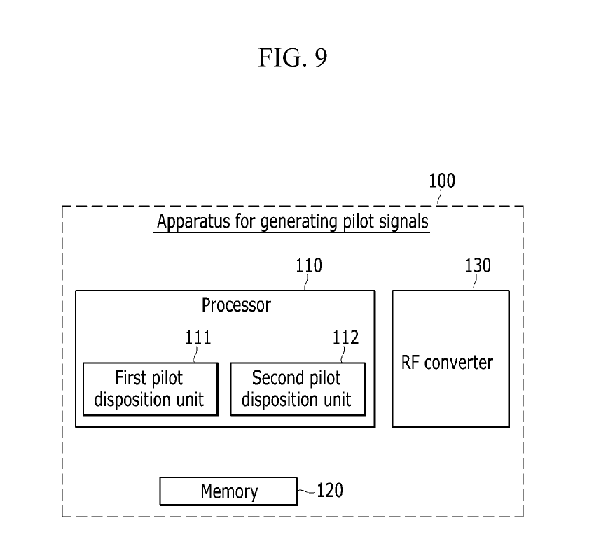

FIG. 9 is a diagram illustrating the configuration of an apparatus for generating pilot signals in accordance with an exemplary embodiment of the present invention.

As illustrated in FIG. 8, the apparatus 100 for generating pilot signals includes a processor 110, memory 120, and a radio frequency (RF) converter 130. The processor 110 may be configured to implement the methods described with reference to FIGS. 3 to 10.

To this end, the processor 110 may include a first pilot disposition unit 111 and a second pilot disposition unit 112.

The first pilot disposition unit 111 disposes a pilot signal at a first interval (e.g., at an interval of three OFDM symbols) in the first range of OFDM symbols that form a transmission frame.

The second pilot disposition unit 112 disposes a pilot signal at a second interval (e.g., at an interval of nine OFDM symbols) in a second range subsequent to the first range of the transmission frame.

The memory 120 is connected to the processor 110 and configured to store various information related to the operation of the processor 110. The RF converter 130 is connected to the processor 110 and configured to send or receive radio signals. Particularly, the RF converter 130 may send and receive pilot signals disposed at different intervals in a first range and a second range.

In accordance with an exemplary embodiment of the present invention, a pilot signal capable of accurately estimating a frequency offset in a high-speed moving environment can be generated. That is, a pilot signal robust against a frequency offset is generated. Accordingly, a small pilot signal can be used, a frequency offset can be estimated, and a transmission capacity can be increased.

The above exemplary embodiments of the present invention are not implemented only by the aforementioned method and apparatus, but may be implemented using a program for realizing a function corresponding to the construction of the exemplary embodiment of the present invention or a recording medium on which the program has been recorded. The implementation may be easily achieved by those having ordinary skill in the art to which the present invention pertains from the above exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of generating pilot signals in an environment in which a terminal moves at a high speed, the method comprising:
disposing pilot signals at a first interval in a first range of a transmission frame forming a single transmission unit; and
disposing pilot signals at a second interval in a second range of the transmission frame.

2. The method of claim 1, wherein
if the transmission frame comprises a plurality of orthogonal frequency division modulation (OFDM) symbols in a time domain,
disposing the pilot signals at the first interval comprises disposing one pilot signal every first number of OFDM symbols, and
disposing the pilot signals at the second interval comprises disposing one pilot signal every second number of OFDM symbols.

3. The method of claim 2, wherein the second number is three times the first number.

4. The method of claim 1, wherein the second range is subsequent to the first range.

5. A method of estimating, by a base station, a frequency offset based on pilot signals in an environment in which a terminal moves at a high speed, the method comprising:
receiving a signal in which pilot signals are disposed at a first interval in a first range of a transmission frame forming a single transmission unit and pilot signals are disposed at a second interval in a second range of the transmission frame;
estimating, by the base station, a first frequency offset based on the pilot signals disposed in the first range of the received signal;
estimating a second frequency offset based on the pilot signals disposed in the second range of the received signal; and
calculating a final frequency offset estimation value based on the first frequency offset and the second frequency offset.

6. The method of claim 5, wherein if the transmission frame comprises a plurality of orthogonal frequency division modulation (OFDM) symbols in a time domain, one pilot signal is disposed every first number of OFDM symbols in the first range, and one pilot signal is disposed every second number of OFDM symbols in the second range.

7. The method of claim 6, wherein the second number is three times the first number.

8. An apparatus for generating pilot signals in an environment in which a terminal moves at high speed, the apparatus comprising:
a radio frequency converter configured to send and receive signals through an antenna; and
a processor connected to the radio frequency converter and configured to generate pilot signals,
wherein the processor is configured to comprise:
a first pilot disposition unit configured to dispose pilot signals at a first interval in a first range of a transmission frame forming a single transmission unit; and
a second pilot disposition unit configured to dispose pilot signals at a second interval in a second range of the transmission frame.

9. The apparatus of claim 8, wherein if the transmission frame comprises a plurality of orthogonal frequency division modulation (OFDM) symbols in a time domain,
the first pilot disposition unit disposing the pilot signals at the first interval comprises disposing one pilot signal every first number of OFDM symbols, and
the second pilot disposition unit disposing the pilot signals at the second interval comprises disposing one pilot signal every second number of OFDM symbols.

10. The apparatus of claim 9, wherein the second number is three times the first number.

11. The apparatus of claim 8, wherein the second range is subsequent to the first range.
